(19) United States
(12) Patent Application Publication
(10) Pub. No.: US 2024/0362899 A1
(43) Pub. Date: Oct. 31, 2024

(54) Behaviour Models for Autonomous Vehicle Simulators

(71) Applicant: Waymo UK Ltd., Oxford (GB)

(72) Inventors: Shimon Azariah Whiteson, Oxford (GB); Joao Messias, Oxford (GB); Xi Chen, London (GB); Feryal Behbahani, London (GB); Kyriacos Shiarli, Oxford (GB); Sudhanshu Kasewa, GURGAON (IN); Vitaly Kurin, Oxford (GB)

(21) Appl. No.: 18/655,018

(22) Filed: May 3, 2024

Related U.S. Application Data
(63) Continuation of application No. 16/978,446, filed on Sep. 4, 2020.

(30) Foreign Application Priority Data
Mar. 6, 2018 (GB) 1803599.8
Nov. 2, 2018 (GB) 1817987.9

(51) Int. Cl. G06V 10/774; G06F 18/214; G06N 3/045; G06V 10/82; G06V 20/40; G06V 20/56

(52) U.S. Cl. CPC G06V 10/774; G06F 18/2155; G06N 3/045; G06V 10/82; G06V 20/46; G06V 20/56

(57) ABSTRACT

The present invention relates to a method of providing behaviour models of and for dynamic objects. Specifically, the present invention relates to a method and system for generating models and/or control policies for dynamic objects, typically for use in simulators and/or autonomous vehicles. The present invention sets out to provide a set or sets of behaviour models of and for dynamic objects, such as, for example, drivers, pedestrians and cyclists, typically for use in such autonomous vehicle simulators.

### CROSS-REFERENCE TO RELATED APPLICATION

This patent application is a continuation (and claims the benefit of priority under USC 120) of U.S. patent application Ser. No. 16/978,446, filed Sep. 4, 2020, which is a National Stage Application under 35 U.S.C. § 371 and claims the benefit of International Application No. PCT/GB2019/050634, filed on Mar. 6, 2019, which claims priority to GB Application No. 1817987.9, filed on Nov. 2, 2018 and GB Application No. 1803599.8, filed on Mar. 6, 2018. The disclosure of the prior applications are considered part of and are incorporated by reference in the disclosure of this application.

### FIELD

The present invention relates to a method of providing behaviour models of and for dynamic objects. Specifically, the present invention relates to a method and system for generating models and/or control policies for dynamic objects, for example for use in simulators and/or autonomous vehicles.

### BACKGROUND

For a typical example of a road scene in the UK, when it is starting to rain and where heavy traffic is merging onto a motorway with roadworks, it is generally accepted that it is non-trivial to programme an autonomous vehicle to handle this example situation. One solution could be to use planning rules, but this is generally accepted to be totally infeasible because the autonomous vehicle has to merge with the existing traffic when it does not have right of way, which involves anticipating the other road users, but critically also requires the autonomous vehicle to act in a way that other road users expect. To programme this in a set of planning rules would require a set of highly complex rules, especially for edge cases like the example given. It follows that it is impossible to test autonomous vehicles in the real world before the vehicle has been programmed or trained, therefore the alternative to real world testing is to use simulators.

The testing and development of autonomous vehicle technology is highly complex and expensive. Currently 99% of autonomous testing is performed in simulated environments, as testing in the real world is prohibitively expensive. Every software update requires it own test and the test itself can be potentially dangerous if carried out on real roads.

One type of model that can be used in simulators to model the behaviour of road users are simple swarm traffic models. However, although these models can deliver models on a large scale, they are not useful for precisely modelling micro-scale effects, i.e. the behaviour of individuals.

Furthermore, as demonstrated above, dynamic objects do not behave in the same manner in every situation. A pedestrian walking along the pavement behaves in an entirely different manner when walking along the pavement and subsequently crossing the road. The pedestrian may cross the road at a designated crossing, like a pelican crossing, or may cross the road unexpectedly when there this a gap in the road.

Other vehicle drivers also exhibit unexpected behaviour, as do cyclists.

Thus, there is a requirement to provide more accurate testing environments, particularly on the micro-scale—i.e. per individual dynamic object within a simulation, for example for use in autonomous vehicle simulators. In particular, there is a requirement for more accurate test environments for the “planning function” of an autonomous vehicle. The planning function is the decision-making module which determines which actions to take in response to the perceived road environment. Testing the planning function in simulation comes with its own challenges. It requires a set or sets of behaviour for other road users which are: highly realistic; freely acting; varied; and able to generate numerous scenarios without specific programming.

The first behaviour of being highly realistic is one of the most challenging in that dynamic objects, especially humans, behave in countless different ways, in any given scenario. A cautious person will not cross a road, in the scenario given above, at any point other than a designated crossing point. A more risk-tolerant person however, who tends towards more “jay-walking” behaviour, will take the first opportunity of crossing the same road in exactly the same situation.

“Freely acting” behaviour is the way in which any dynamic object responds towards the autonomous vehicle being tested. Again, no two dynamic objects will respond in the same way. One person seeing a slow moving bus coming towards them will take the opportunity to cross the road in front of it, whilst another may, in the same scenario, will be more cautious and wait for the bus to pass. In the same way, dynamic object behaviour is, and can be unexpectedly, varied. Thus millions of different scenarios are required for training in or training autonomous vehicular simulators.

### SUMMARY OF INVENTION

Aspects and/or embodiments set out to provide a set or sets of behaviour models of and for dynamic objects, such as, for example, drivers, pedestrians and cyclists, for use in for example autonomous vehicle simulators as well as other use cases.

Aspects and/or embodiments make use of real-life demonstrations, i.e. video imagery from traffic cameras, which record real-life behaviour, combined with the use of computer vision techniques to detect and identify dynamic objects in the scene observed in the video imagery and subsequently to track the detected and identified dynamic object trajectories. This may be done frame-by-frame from the video imagery. The extracted trajectories can then be used as input data to “Learning from Demonstration” (LfD) algorithms. The output of these LfD algorithms is a “control policy” for each identified dynamic object. The control policy is a learned policy, or rather, a learned model of behaviour of the identified dynamic object. For example, this may be a behavioural model of a pedestrian walking on the pavement and subsequently crossing the road in front of an autonomous vehicle.

According to a first aspect, there is provided a computer implemented method of creating behaviour models of dynamic objects, said method comprising the steps of: a) identifying a plurality of dynamic objects of interest from sequential image data, the sequential image data comprising a sequence of frames of image data; b) determining trajectories of said dynamic objects between the frames of the sequential image data; and c) determining a control policy for said dynamic objects from the determined trajectories, wherein said step of determining comprises the steps of: i) determining generated behaviour by a generator network; ii) determining a demonstration similarity score, wherein the demonstration similarity score is a measure of the similarity of said generated behaviour by a discriminator network to predetermined trajectory data of real dynamic objects; iii) providing said demonstration similarity score back to the generator network; iv) determining revised generated behaviours by the generator network wherein the generator network uses said demonstration similarity score as a reward function; and v) repeating any of steps i) to iv) to determine revised generated behaviours until the demonstration similarity score meets a predetermined threshold.

Optionally, the generator network is a Generative-Adversarial Artificial Neural Network Pair (GAN).

Optionally, the method is used with any or any combination of: autonomous vehicles; simulators; games; video games; robots; robotics.

Optionally, dynamic objects include any or any combination of: humans; pedestrians; crowds; vehicles; autonomous vehicles; convoys; queues of vehicles; animals; groups of animals; barriers; robots.

Optionally, the method further comprises the step of converting said trajectories from two-dimensional space to three-dimensional space.

Optionally, the step of determining a control policy uses a learning from demonstration algorithm.

Optionally, the step of determining a control policy uses an inverse reinforcement learning algorithm.

Optionally, the step of using said demonstration similarity score as a reward function comprises the generator network using the demonstration similarity score to alter its behaviour to reach a state considered human-like.

Optionally, the step of repeating any of steps i) to iv) comprises obtaining a substantially optimal state where said generator network obtains a substantially maximum score for human-like behaviour from the discriminator network.

Optionally, either or both of the generator network and/or the discriminator network comprise any or any combination of: a neural network; a deep neural network; a learned model; a learned algorithm.

Optionally, the image data is obtained from any or any combination of: video data; CCTV data; traffic cameras; time lapse images; extracted video feeds; simulations; games; instructions; manual control data; robot control data; user controller input data.

Optionally, the sequential image data is obtained from on-vehicle sensors.

Optionally, only a single camera (or single monocular camera of ordinary resolution) is used to infer the location of objects in three dimensional space.

According to a second aspect, there is provided a system for creating behaviour models of dynamic objects, said system comprising: at least one processor adapted to execute code, the code operable to perform the computer implemented method of creating behaviour models of dynamic objects, said method comprising the steps of: a) identifying a plurality of dynamic objects of interest from sequential image data, the sequential image data comprising a sequence of frames of image data; b) determining trajectories of said dynamic objects between the frames of the sequential image data; and c) determining a control policy for said dynamic objects from the determined trajectories, wherein said step of determining comprises the steps of: i) determining generated behaviour by a generator network; ii) determining a demonstration similarity score, wherein the demonstration similarity score is a measure of the similarity of said generated behaviour by a discriminator network to predetermined trajectory data of real dynamic objects; iii) providing said demonstration similarity score back to the generator network; iv) determining revised generated behaviours by the generator network wherein the generator network uses said demonstration similarity score as a reward function; and v) repeating any of steps i) to iv) to determine revised generated behaviours until the demonstration similarity score meets a predetermined threshold.

According to a third aspect, there is provided a storage device that includes machine-readable instructions that when executed by at least one processor, cause said at least one processor to carry out the computer implemented method of creating behaviour models of dynamic objects, said method comprising the steps of: a) identifying a plurality of dynamic objects of interest from sequential image data, the sequential image data comprising a sequence of frames of image data; b) determining trajectories of said dynamic objects between the frames of the sequential image data; and c) determining a control policy for said dynamic objects from the determined trajectories, wherein said step of determining comprises the steps of: i) determining generated behaviour by a generator network; ii) determining a demonstration similarity score, wherein the demonstration similarity score is a measure of the similarity of said generated behaviour by a discriminator network to predetermined trajectory data of real dynamic objects; iii) providing said demonstration similarity score back to the generator network; iv) determining revised generated behaviours by the generator network wherein the generator network uses said demonstration similarity score as a reward function; and v) repeating any of steps i) to iv) to determine revised generated behaviours until the demonstration similarity score meets a predetermined threshold.

Use can also be made of pre-recorded films of people and/or animals acting in a scene in a film. All of these scenarios may play a part in the way data on and of dynamic objects is obtained.

Image and/or video data is collected from various sources showing dynamic object behaviour in real-world traffic scenes. This data can consist of monocular video taken by standard roadside CCTV cameras, for example. Computer vision algorithms are then applied to extract relevant dynamic features from the collected data such as object locations, as well as extracting static features such as the position of the road and geometry of the scene. Such visual imagery data may also be obtained from public and private geospatial data sources like, for example, Google Earth, Google Street View, OpenStreetCam, Bing Maps, etc.

For each video that is collected, the intrinsic and extrinsic parameters of the recording camera can be estimated through a machine learning method which, herein, is referred to as “camera calibration through gradient descent”. This method can establish a projective transformation from a 3D reference frame in real-world coordinates onto the 2D image plane of the recording camera. By exploiting constraints on the known geometry of the scene (for instance, the real-world dimensions of road vehicles, pedestrians, cyclists, etc), an approximate inverse projection can also be obtained, which can be used to estimate the 3D positions and/or trajectories that correspond to the 2D detections of road users. These 3D positions can then be filtered through existing multi-hypothesis tracking algorithms to produce 3D trajectories for each detected dynamic object, for example, road users, pedestrians, cyclists, etc.

The collected trajectory data and the respective scene context can be processed by “Learning from demonstration” (or “LfD”) techniques to produce control systems capable of imitating and generalising the recorded behaviour in similar conditions. In particular, the focus is on LfD through an Inverse Reinforcement Learning (IRL) algorithm. Using this algorithm, a cost function can be obtained that explains the observed demonstrations as reward-seeking behaviour. The IRL algorithm used within aspects and/or embodiments can be implemented by means of a Generative-Adversarial Artificial Neural Network Pair (or “GAN”), in which a generator network can be trained to produce reward-seeking behaviour and a Discriminator Network (or “DN”) can be trained to distinguish between the generated behaviour and the recorded demonstrations, producing in turn a measure of cost that can be used to continuously improve the generator. The DN is a neural network which can compare the generated behaviour to demonstration behaviour. The generator network can take as its input a feature representation that is based on the relative positions of a simulated road object to all others as well in the scene, as well as on the static scene context, and outputs a target displacement to the position of that dynamic object. To stabilise the learning process and improve the generator's ability to generalise to unseen states, a curriculum training regime is employed, in which the number of timesteps for which the generator interacts with the simulator is gradually increased. At convergence, the generator network can induce a motion on the simulated dynamic object that is locally optimal with respect to a measure of similarity to the demonstrations observed from the camera footage.

The learned generator network can then be used as a control system to drive simulated dynamic objects in a traffic simulation environment. Aspects and/or embodiments do not provide or depend on a particular traffic simulation environment-instead, by means of a suitable software interface layer, the learned control system can generate a control policy which can be deployed into any traffic simulation environment. The system can be adapted in the following ways:
1) to provide the locations of the simulated dynamic objects;
2) to provide a description of the static context for the simulated traffic scene, including the positions of roads, traffic signs, and any other static features that may be relevant to the behaviour of simulated dynamic objects; and
3) to accept external control of the simulated dynamic objects, i.e. all road users.

The output behaviour models of dynamic objects of some aspects/embodiments can thus be highly realistic, which is a result of the algorithm using actual human behaviours and learning a control policy which replicates these behaviours. The control policy is a model for behaviour for the dynamic objects.

The control policies of the aspects and/or embodiments can thus able to generate scenarios which are:
1. Highly realistic. The Learning from Demonstration (LfD) algorithm can take actual human behaviours and learn a control policy which replicates these. One component of the LfD algorithm is a “Discriminator” whose role is to work out whether the behaviour is human-like or not, through comparing it to the demonstrations. The responses from this Discriminator can be used to train the control policy in human-like behaviour;
2. Freely acting: the output of the LfD algorithm is a “control policy”. This can take in an observation from the environment, process it, and respond with an action-representing the best action it thinks it can take in this situation in order to maximise the “human-like-ness” of its behaviour. In this way, each action step will be a specific response to the observations from the environment, and will vary depending on these observations;
3. Varied: the LfD algorithm can learn behaviours based on the data extracted from the computer vision team using real traffic camera footage. The footage will naturally include a range of behaviour types (e.g. different driving styles, different times of day, different weather conditions, etc). When the control policy is outputting a human-like action, it will select the action from a probability distribution of potential outcomes, which it has observed from the data. This requires it to identify “latent variables” in the behaviours it outputs—these latent variables represent specific styles of behaviour which implicitly exist in the input data;
4. The algorithm is able to generate millions of scenarios:
   a) the programming of the LfD algorithm allows it to run at a rapid frame rate which facilitates the generation of millions of scenarios rapidly. Other methods are not able to compute a response to the environment as quickly; and
   b) as the algorithm is “freely acting”, rather than programmed to follow a specific behaviour, it is able to iterate through millions of different scenarios without requiring manual intervention.

### BRIEF DESCRIPTION OF THE DRAWINGS

Some embodiments are herein described, by way of example only, with reference to the accompanying drawings having like-reference numerals, in which:

FIG. 1 is an illustration showing a general overview of a simplified embodiment showing the process of data collection, extraction of input data from the collected data, learning from demonstration based on the input data, and generation of control policies that are then accessible via an API to simulators;

FIG. 2 is an illustration of a more detailed view of the overall architecture of an example implementation embodiment; and

FIG. 3 is an illustration of an example embodiment of a hierarchical learning from demonstration implementation.

### SPECIFIC DESCRIPTION

Machine learning is the field of study where a computer or computers learn to perform classes of tasks using the feedback generated from the experience or data that the machine learning process acquires during computer performance of those tasks.

Most machine learning is supervised learning, which is concerned with a computer learning one or more rules or functions to map between example inputs and desired outputs as predetermined by an operator or programmer, usually where a data set containing the inputs is labelled.

When the goal is not just to generate output given an input but to optimise a control system for an autonomous agent such as a robot, the standard paradigm is reinforcement learning, in which the system learns to maximise a manually defined reward signal. This approach is effective when the goals of the human designer of the system can be readily quantified in the form of such a reward signal.

However, in some cases, such goals are hard to quantify, e.g., because they involve adhering to nebulous social norms. In such cases, an alternative paradigm called learning from demonstration (LfD) can be used, in which the control system is optimised to behave consistently with a set of example demonstrations provided by a human who knows how to perform the task correctly. Hence, LfD requires only the ability to demonstrate the desired behaviour, not to formally describe the goal that that behaviour realises.

With specific reference now to the drawings in detail, it is stressed that the particulars shown are by way of example only and for purposes of illustrative discussion of aspects and/or embodiments only. In this regard, the description, taken with the drawings, makes apparent to those skilled in the art how various aspects and several embodiments may be implemented.

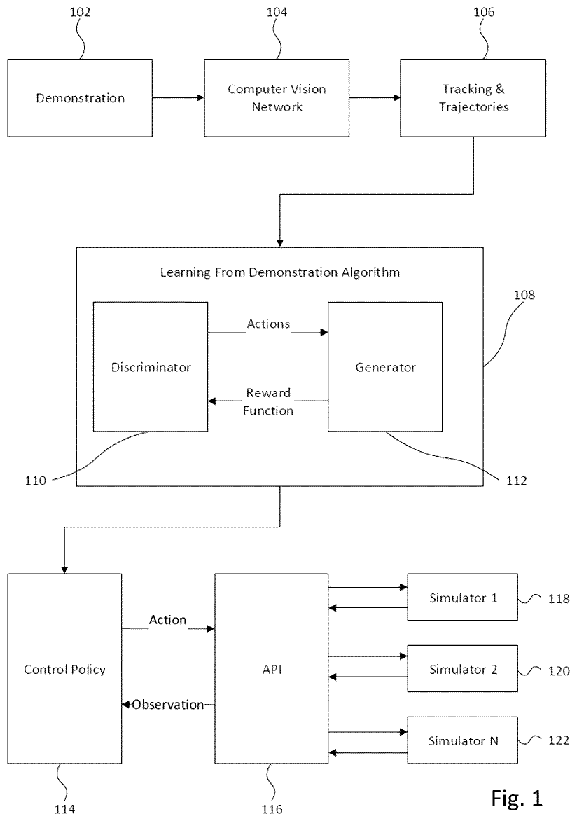

Referring firstly to FIG. 1, there is shown a general overview of a simplified embodiment.

The input data is collected video and/or image data 102, so for example video data collected from video cameras, which provides one or more demonstrations of the behaviour of one or more respective dynamic objects. This input data 102 is provided to a computer vision neural network 104.

The computer vision network 104 analyses the demonstration(s) in the input data 102 frame-by-frame to detect and identify the one or more dynamic objects in the input data 102. Next, from the detected and identified dynamic object(s) in the input data 102, the dynamic objects are identified across multiple images/frame of video and their trajectories are tracked and determined 106 across the multiple images/frame of video. In some embodiments the MaskRCNN approach is used to perform object detection. In some embodiments, Bayesian reasoning is performed with Kalman filters, using principled probabilistic reasoning to quantify uncertainty about the locations of tracked objects over time.

The dynamic objects and their tracked trajectories are input into the “Learning from Demonstration Algorithm” 108. The LfD algorithm 108 comprises a Discriminator module 110 and a Generator module 112.

The Discriminator module 110 is a neural network that compares the control policy generated per dynamic object behaviour to actual dynamic object behaviour (the demonstration) and is able to discriminate the two.

The generator network 112 in turn generates a control policy per dynamic object. The output of the generator network 112 is then “scored” by the Discriminator 110. This score is the “reward function” which is then fed back to the generator 112, which prompts the generator 112 to change its generated behaviour per dynamic object to obtain a better score from the Discriminator 110 (i.e. make the behaviour more human-like).

The iterative progress carried out by the LfD algorithm 108 yields a control policy 114 which is a model of behaviour exhibited by each dynamic object. This policy 114 can be used to provide each virtual dynamic object with a set of rules to behave by or rather actions to take. The actions are processed by the API 116 and translated into a form suitable to each simulator 118, 120, 122, which provides an observation back to the API 116. This observation is itself translated by the API 116 into a form suitable for the control policy 114 and sent on to that control policy 114, which uses the observation to select the next action. In this way the system “learns from demonstration”.

The LfD takes place in the sub-system LfD Algorithm 108. This sub-system outputs the Control Policy (CP) 114 once the learning has been completed (i.e. the behaviour produced by the generator is totally human-like or at least to a threshold of human-like behaviour.

The API 116 integrates the control policy into one or more simulated environments 118, 120, 122.

The simulators 118, 120, 122 provide, via the API 116 to the control policy/policies 114, the inputs the control policy 114 requires to make a decision about what action to take (namely the environment around the dynamic object it is controlling and the location of other dynamic objects in the scene), the CP 114 receives that information and makes a decision on what action to take (based on the behaviour model it has learned) and then outputs that decision (i.e. an action, for example, a movement towards a particular point) back into the respective simulator(s) 118, 120, 122 via the API 116. This is repeated for every action that occurs.

The above steps are not necessarily carried out in the same order every time and are not intended to limit the present invention. A different order of the steps outlined above and defined in the claims may be more appropriate for different scenarios. The description and steps outlined should enable the person skilled in the art to understand and to carry out the present invention.

The above steps establish a Control Policy 114 which can be deployed in one or more simulated environments 118, 120, 122 via an API 116. The CP 114 receives information from the simulated environment(s) 118, 120, 122 regarding the positions of its dynamic objects, and outputs actions for the behaviour of dynamic objects back via the API 116, which are fed into the simulator(s) 118, 120, 122. The simulator(s) 118, 120, 122 may be any simulated environment which conforms to the following constraints:
1—the simulator(s) can send the positions of its dynamic objects to the CP 114 through the API 116;
2—the simulator(s) can change the positions of its dynamic objects based on the output of the CP 114 received through the API 116. Aspects and/or embodiments may therefore be deployed to potentially different simulators 118, 120 and 122, etc.

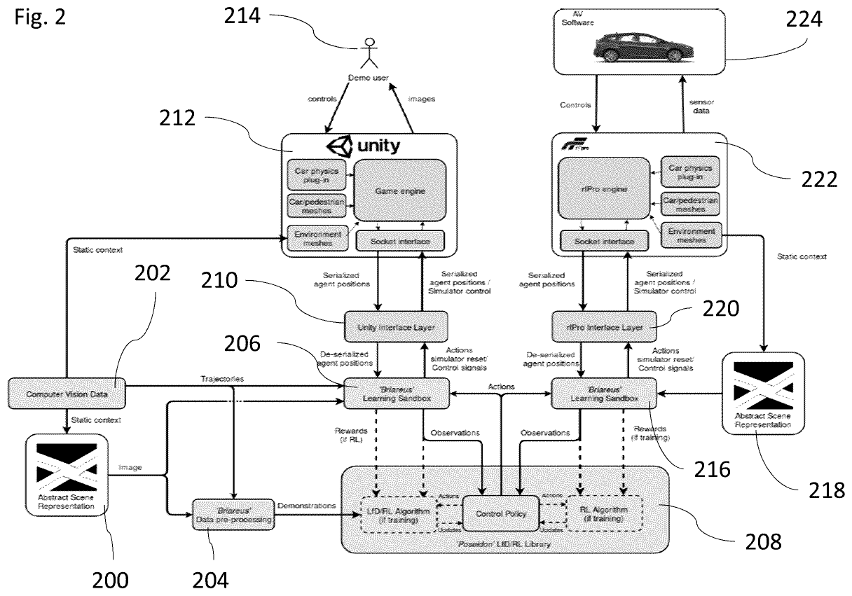

Referring now to FIG. 2, there is shown an overview of a more detailed implementation of the learning from demonstration architecture that can be implemented according to another embodiment.

The implementation receives input from video cameras, or any sensors in the vehicles etc, the data from which are analysed using computer vision 202 to produce computer vision or image data of the dynamic objects 200, 204.

This data is used to establish Control Policies 208. The CPs 208 may be uploaded or otherwise assessed by the autonomous vehicle simulators 210, 212, 214. The tested CPs may subsequently be used by customers 220, 222, 224, for example, autonomous vehicle simulators, simulator providers, insurers, regulators, etc.

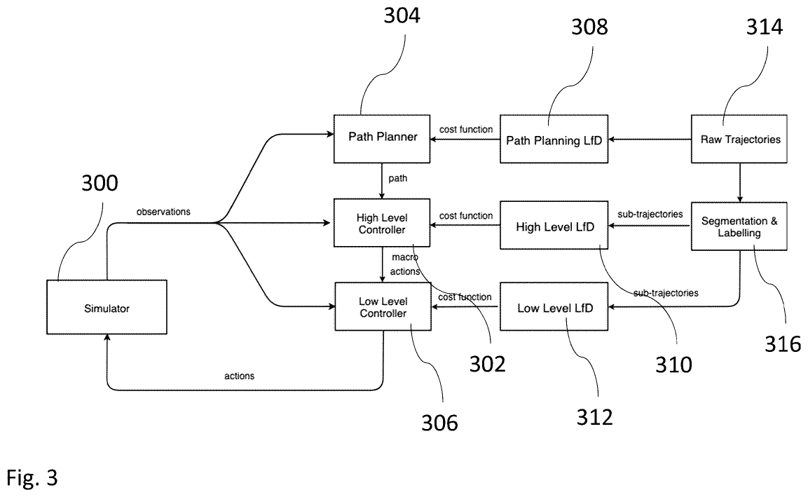

Referring now to FIG. 3, there is shown an alternative embodiment of the LfD module. In this embodiment, a hierarchical approach is taken in which the control policy produced by LfD is decomposed into three parts.

The first part is a path planner 304, which determines how to navigate from an initial location to a given destination while respecting road routing laws, as well as what path to take to execute that navigation, while taking static context (i.e., motionless obstacles) into account.

The second part is a high-level controller 302 that selects macro actions specifying high level decisions about how to follow the path (e.g., whether to change lanes or slow down for traffic lights) while taking dynamic context (i.e., other road users) into account.

The third part is a low-level controller 306 that makes low level decisions about how to execute the macro actions selected by the high-level controller and directly determines the actions (i.e., control signals) output by the policy, while also taking dynamic context into account.

In this hierarchical approach, LfD 308, 310, 312 can be performed separately for each part, in each case yielding a cost function that the planner or controller then seeks to minimise. As set out in the above embodiments, LfD can be implemented in parallel processes for each of the path planner 304, low-level controller 306 and high-level controller 302.

For the path planning LfD 308, the raw trajectories (i.e., the output of the computer vision networks shown in FIG. 1) can be directly used for LfD.

For the high- and low-level controllers, the trajectories 314 are output from the path planning LfD 308 and are first processed by another module 316 that segments the trajectories into sub-trajectories and labels each with the appropriate macro action which are then fed into the High level LfD 310 and the Low Level LfD 312.

In this hierarchical approach, for the dynamic object in the Simulator 300, the Path Planner 304 outputs the path decision to the High Level controller 302. The High Level controller 302 then uses the input path decision from the Path Planner 304 to generate outputs of one or more macro actions, which it passes to the Low Level Controller 306. In turn, the Low Level Controller 306 receives the one or more macro actions from the High Level controller 302 and processes these to output actions which are sent back to the Simulator 300 for the dynamic object to execute within the simulation.

Applications of the above embodiments can include video games, robotics, and autonomous vehicles but other use cases should be apparent where human-like complex behaviour needs to be modelled.

Video games as a use case would seem to lend themselves particularly to the use of aspect and/or embodiments as set out here. There is typically copious demonstration data available in the form of gameplay logs and videos, which can be used as the input to train and refine the learning from development approach set out above on a different data set to that given in the examples above. Depending on the game, the computer vision approach will typically require minimal modification as the same techniques and objections will be applicable, e.g., mapping from 2D to 3D. Once trajectories for dynamic objects within the game environment are available, the same LfD approach can be applied as set out in the aspects/embodiments above. For game applications, both the computer vision and LfD processes may simplified by the fact that instead of the use of a simulator, the video game environment itself serves that role.

The same principles should also apply in robotics applications. If one collects video data of humans performing a task, e.g. warehouse workers, the aspects/embodiments set out above can be used to interpret the videos of demonstrations of the task of interest being performed to learn policies for a robot that will replace those humans. It will be apparent that the robot will need to have similar joints, degrees of freedom, and sensors in order to do the mapping but some approximations may be possible where the robot has slightly restricted capabilities compared to the human worker. The aspects/embodiments can also learn from demonstrations consisting of a human manually controlling a robot with arbitrary sensors and actuators, though directly recording the sensations and control signals of the robot during the demonstration may be performed in addition or instead of using video data to learn from the demonstration of the operation of the robot.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

1. A computer-implemented method for controlling an agent interacting with an environment using a control neural network comprising at least (i) a path planning network having a first set of network parameters and (ii) a high-level action control network having a second set of network parameters, the method comprising:
at each of a plurality of steps, performing:
obtaining an observation of the environment at a current step;
processing a first input comprising data characterizing the observation at the current step using the path planning network, according to values of the first set of network parameters, to generate a path planning output specifying a planned trajectory for the agent;
processing a second input comprising data characterizing (i) the observation at the current step and (ii) the planned trajectory generated by the path planning network using the high-level action control network, according to values of the second set of network parameters, to generate a high-level action control output specifying one or more planned actions for the agent;
generating, using the planned actions generated by the high-level action control network, control data for the agent for the current step; and
controlling the agent using the control data to interact with the environment.

2. The method of claim 1, wherein:
the control neural network further comprises a low-level action control network having a third set of network parameters;
generating the control data comprises:
processing a third input comprising data characterizing (i) the observation at the current step and (ii) the one or more planned actions specified by the high-level action control output using the low-level action control network, according to values of the third set of network parameters, to generate a low-level action control output specifying one or more control signals for the agent; and
controlling the agent using the control data to interact with the environment comprises:
applying the control signals specified in the low-level action control output to the agent.

3. The method of claim 1, wherein the environment is a simulated environment, and obtaining the observation of the environment at the current step comprises:
performing a simulation of the agent interacting with the simulated environment to generate a simulated observation.

4. The method of claim 3, wherein the simulated environment comprises one or more other simulated agents that are controlled by one or more respective control models.

5. The method of claim 1, wherein the agent is one of: a vehicle, a vehicle convoy, a pedestrian, or a robotic agent.

6. The method of claim 1, wherein the one or more planned actions specified by the high-level action control output comprise: a turn, a lane switch, or a change of speed.

7. The method of claim 1, wherein the control neural network has been trained in a reinforcement learning process using a sequence of frames of image data recorded from a real-world scene.

8. The method of claim 7, wherein the reinforcement learning process comprises:
processing the image data to determine one or more object trajectories for a dynamic object in the real-world scene;
generating, from each of the one or more object trajectories, a set of plurality of trajectory sections;
determining a respective label for each trajectory section that represents one or more actions for the trajectory section;
at each of a plurality of iterations:
generating a simulated observation in response to one or more actions of a simulated agent in a simulated environment;
processing first data characterizing the simulated observation using the path planning network, according to current values of the first set of network parameters, to generate a first output specifying a planned trajectory for the simulated agent;
processing second data characterizing (i) the simulated observation and (ii) the planned trajectory generated by the path planning network using the high-level action control network, according to current values of the second set of network parameters, to generate a second output specifying one or more planned actions for the simulated agent;
determining a first similarity score characterizing a first similarity between (i) the planned trajectory generated by the path planning network and (ii) the object trajectories determined for the planned trajectory for the dynamic object in the real-world scene;
adjusting values of the first set of network parameters based on a first reward determined from the first similarity score;
determining a second similarity score characterizing a second similarity between (i) the planned actions generated by the high-level action control network and (ii) the respective labels determined for the trajectory sections of the dynamic object in the real-world scene; and
adjusting values of the second set of network parameters based on a second reward determined from the second similarity score.

9. The method of claim 8, further comprising:
converting the one or more trajectories from two-dimensional space to three-dimensional space.

10. The method of claim 7, wherein the sequence of frames of image data is obtained from on-vehicle sensors.

11. A system for controlling an agent interacting with an environment using a control neural network comprising at least (i) a path planning network having a first set of network parameters and (ii) a high-level action control network having a second set of network parameters, the system comprising:
one or computers and one or more storage devices storing instructions that when executed by the one or more computers cause the one or more computers to perform operations comprising:
at each of a plurality of steps, performing:
obtaining an observation of the environment at a current step;
processing a first input comprising data characterizing the observation at the current step using the path planning network, according to values of the first set of network parameters, to generate a path planning output specifying a planned trajectory for the agent;
processing a second input comprising data characterizing (i) the observation at the current step and (ii) the planned trajectory generated by the path planning network using the high-level action control network, according to values of the second set of network parameters, to generate a high-level action control output specifying one or more planned actions for the agent;
generating, using the planned actions generated by the high-level action control network, control data for the agent for the current step; and
controlling the agent using the control data to interact with the environment.

12. The system of claim 11, wherein:
the control neural network further comprises a low-level action control network having a third set of network parameters;
generating the control data comprises:
processing a third input comprising data characterizing (i) the observation at the current step and (ii) the one or more planned actions specified by the high-level action control output using the low-level action control network, according to values of the third set of network parameters, to generate a low-level action control output specifying one or more control signals for the agent; and
controlling the agent using the control data to interact with the environment comprises:
applying the control signals specified in the low-level action control output to the agent.

13. The system of claim 11, wherein the environment is a simulated environment, and obtaining the observation of the environment at the current step comprises:
performing a simulation of the agent interacting with the simulated environment to generate a simulated observation.

14. The system of claim 13, wherein the simulated environment comprises one or more other simulated agents that are controlled by one or more respective control models.

15. The system of claim 11, wherein the agent is one of: a vehicle, a vehicle convoy, a pedestrian, or a robotic agent.

16. The system of claim 11, wherein the one or more planned actions specified by the high-level action control output comprise: a turn, a lane switch, or a change of speed.

17. The system of claim 11, wherein the control neural network has been trained in a reinforcement learning process using a sequence of frames of image data recorded from a real-world scene.

18. One or more non-transitory computer-readable storage media storing instructions that when executed by one or more computers cause the one or more computers to perform operations for controlling an agent interacting with an environment using a control neural network comprising at least (i) a path planning network having a first set of network parameters and (ii) a high-level action control network having a second set of network parameters, the operations comprising:
at each of a plurality of steps, performing:
obtaining an observation of the environment at a current step;
processing a first input comprising data characterizing the observation at the current step using the path planning network, according to values of the first set of network parameters, to generate a path planning output specifying a planned trajectory for the agent;
processing a second input comprising data characterizing (i) the observation at the current step and (ii) the planned trajectory generated by the path planning network using the high-level action control network, according to values of the second set of network parameters, to generate a high-level action control output specifying one or more planned actions for the agent;
generating, using the planned actions generated by the high-level action control network, control data for the agent for the current step; and
controlling the agent using the control data to interact with the environment.

19. The one or more non-transitory computer-readable storage media of claim 18, wherein:
the control neural network further comprises a low-level action control network having a third set of network parameters;
generating the control data comprises:
processing a third input comprising data characterizing (i) the observation at the current step and (ii) the one or more planned actions specified by the high-level action control output using the low-level action control network, according to values of the third set of network parameters, to generate a low-level action control output specifying one or more control signals for the agent; and
controlling the agent using the control data to interact with the environment comprises:
applying the control signals specified in the low-level action control output to the agent.

20. The one or more non-transitory computer-readable storage media of claim 18, wherein the environment is a simulated environment, and obtaining the observation of the environment at the current step comprises:
performing a simulation of the agent interacting with the simulated environment to generate a simulated observation.
